(19) United States
(12) Patent Application Publication
(10) Pub. No.: US 2011/0008597 A1
(43) Pub. Date: Jan. 13, 2011

(54) SURFACE PROTECTIVE SHEET

(75) Inventors: Fumiteru ASAI, Ibaraki-shi (JP); Takatoshi SASAKI, Ibaraki-shi (JP); Noriyoshi KAWASHIMA, Ibaraki-shi (JP)

Correspondence Address: SUGHRUE MION, PLLC, 2100 PENNSYLVANIA AVENUE, N.W., SUITE 800, WASHINGTON, DC, 20037, US

(73) Assignee: NITTO DENKO CORPORATION, Osaka (JP)

(21) Appl. No.: 12/834,541

(22) Filed: Jul. 12, 2010

(30) Foreign Application Priority Data
Jul. 13, 2009 (JP) 2009-164705

(51) Int. Cl. C09J 7/02; B32B 7/02

(52) U.S. Cl. 428/213; 428/343; 428/332; 428/345; 428/355 AC

(57) ABSTRACT

A surface protective sheet comprises an adhesive layer having a plurality of layers on one side of a base film, the adhesive layer having a 25° C. storage elastic modulus of 10 to 100 MPa, and an adhesive strength with respect to a silicon mirror wafer of 1.0 N/20 mm or less at peeling off the surface protective sheet. The surface protective sheet is used for a semiconductor wafer having a protruding electrode of 10 to 150 μm height on its surface.

### CROSS-REFERENCE TO RELATED APPLICATIONS

This application claims priority to Japanese Patent Application No. JP2009-164705 filed on 13 Jul. 2009. The entire disclosure of Japanese Patent Application No. JP2009-164705 is hereby incorporated herein by reference.

### BACKGROUND

1. Technical Field

The present invention relates to a surface protective sheet, and more particularly relates to a re-peelable surface protective sheet that is used in a semiconductor manufacturing process.

2. Related Art

There is a known method in which a surface protective sheet is affixed to the surface of a semiconductor wafer to protect the wafer surface and prevent damage to the wafer during grinding of the rear face of the semiconductor wafer and so forth. That is, when the rear face of a semiconductor wafer is being ground, the wafer surface must be protected to prevent damage to any bumps (concave-convex shape) on the wafer surface, fouling of the wafer surface by wafer grinding debris or grinding water, or the like. After grinding, the wafer itself is extremely thin and brittle, and since the wafer surface has bumps, even a slight external force can cause damage.

Particularly with a semiconductor wafer having a protruding electrode on the wafer circuit face, there is an increased risk that stress will damage the semiconductor wafer when a surface protective sheet is peeled away from a wafer that has been ground down extremely thin.

In light of this, a surface protective tape has been proposed for a semiconductor wafer having a protruding electrode on its surface (for example, JP-H11-343469-A).

However, even with a surface protective sheet such as this, it does not adequately conform to the bumps on the semiconductor wafer, and peeling stress can still sometimes lead to damage to the semiconductor wafer.

### SUMMARY

The present invention was conceived in light of the above problems, and it is an object thereof to provide a surface protective sheet with improved conformity to surface irregularities, such as a protruding electrode, on the semiconductor wafer, with which good wafer bondability (or adhesiveness) can be achieved, and with which wafer damage when the sheet is peeled off can be effectively prevented.

The present invention provides a surface protective sheet comprising an adhesive layer having a plurality of layers on one side of a base film,
the adhesive layer having a 25° C. storage elastic modulus of 10 to 100 MPa, and an adhesive strength with respect to a silicon mirror wafer of 1.0 N/20 mm or less at peeling off the surface protective sheet, and
the surface protective sheet being used for a semiconductor wafer having a protruding electrode of 10 to 150 μm height on its surface.

In the above surface protective sheet, the adhesive layer may have a thickness greater than the height of the protruding electrode.

The adhesive layer may have an outermost layer made of a radiation curing type of adhesive.

The adhesive layer may have an outermost layer being the thinnest layer.

At least one of the plurality of layers in the adhesive layer may contain an acrylic polymer having a carbon-carbon double bond, as a main component.

According to the present invention, good wafer bondability can be achieved by the surface protective sheet with improved conformity to surface irregularities, such as a protruding electrode, on the semiconductor wafer. Also, the wafer damage can be effectively prevented when the sheet is peeled off.

### DETAILED DESCRIPTION OF EXEMPLARY EMBODIMENTS

A surface protective sheet of the present invention mainly comprises a base film and an adhesive layer.

The adhesive layer of the surface protective sheet of the present invention is formed by lamination of a plurality of adhesive layers on one side of the base film. The benefit of thus using a plurality of adhesive layers is that even if there is a large bump (i.e., concave-convex shape or irregularity) on the surface being bonded of an adherend, the adhesive layer will deform suitably and be able to conform well to that bump, so a surface protective sheet can be affixed with good adhesion to the adherend surface.

The surface protective sheet of the present invention is used in the manufacture of semiconductor devices, and can be peeled off more than once. There are no particular restrictions on the adherend material to which this surface protective sheet is bonded, but examples include semiconductor wafers, glass, ceramics, metals, plastics, and other such smooth or irregular surfaces. This surface protective sheet can be used to particular advantage on semiconductor wafers or the like, and especially as a fixing surface protective sheet for semiconductor wafers or a protective/masking surface protective sheet for semiconductor wafers, that is affixed to one side of a semiconductor wafer having a bump (such as a protruding electrode) of a specific height (such as about 10 to 150 μm) on its surface.

It is suitable that the adhesive layer is adjusted to a suitable hardness.

If the adhesive layer is too soft, the shape stability of the surface protective sheet may decrease, which can lead to undesirable deformation of the surface protective sheet after long-term storage or under heavy loads, for example. Also, pressure exerted on the surface protective sheet can cause the adhesive layer to ooze out from the surface protective sheet and foul the semiconductor wafer or a manufacturing apparatus. On the other hand, if the adhesive layer is too hard, it will not conform well to bumps on the semiconductor wafer surface, and water may get in through gaps between the adhesive layer and the wafer during thin-film working of the semiconductor wafer, or cracks and dimples may develop on the wafer. For example, when the surface protective sheet is peeled away from a semiconductor wafer that has been thinned by grinding of the semiconductor wafer surface, the peeling resistance increases at the protruding electrode portion, and this can cause damage to the wafer.

Thus, when the surface protective sheet is peeled off, it is suitable for the adhesive layer to have a 25° C. storage elastic modulus of about 10 kPa to 100 MPa, preferably about 10 kPa to 80 MPa, more preferably about 30 kPa or more, and still more preferably about 50 kPa or more, further, preferably about 2000 kPa or less, and more preferably about 1000 kPa or less. The 25° C. storage elastic modulus here is a parameter indicating the “elastic modulus” at 25° C. in kinematic viscoelasticity measurement, and if it is adjusted to within the above range, the surface protective sheet can be easily peeled off without damaging the wafer.

As will be discussed below, the adhesive layer can be formed by any adhesive that is known in this field, but in the case of a radiation curing adhesive, for example, the storage elastic modulus means a storage elastic modulus of the adhesive layer after radiation curing.

The storage elastic modulus of the surface protective sheet can be adjusted by warming when the sheet is peeled off.

Also, the adhesive layer is preferably adjusted to suitable adhesive properties. If the adhesive strength with the wafer is too high, the peeling force when the sheet is peeled off will lead to damage of the semiconductor wafer. Thus, the adhesive strength with respect to a silicon mirror wafer is preferably about 1.0 N/20 mm or less, and more preferably about 0.8 N/20 mm or less when the surface protective sheet is peeled off. If the adhesive layer is formed from a radiation curing adhesive (discussed below), the value after radiation curing is preferably within this range.

It is suitable for the adhesive layer to have a gel content that is no more than about 80 wt % of the total weight of the adhesive. If the adhesive used in the adhesive layer in this case is a radiation curing type, this refers to the gel content of the adhesive layer prior to radiation curing.

It is particularly preferable for the gel content of a first adhesive layer disposed closest to the base film to be about 80 wt % or less, and more preferably about 60 wt %. If the gel content is too high, when the surface protective sheet is affixed to the patterned surface of a semiconductor wafer, polymer movement will be poor, the sheet will not conform well to the bumps, and wafer cracking and dimpling will tend to occur in the thin-film working of the wafer.

The “gel content” referred to here is the proportion (wt %) of the adhesive forming the adhesive layer that does not dissolve after soaking for 7 days at 25° C. in a mixed solvent of toluene and ethyl acetate (1:1 weight ratio).

The adhesive layer in the present invention preferably satisfies both of the above-mentioned conditions for storage elastic modulus and gel content.

It is suitable for there to be at least two adhesive layers, with two to four layers being preferable.

It is suitable for the thickness of the adhesive layer as a whole to be greater than the height of the bumps (such as a protruding electrode) on the semiconductor wafer to which it is affixed. Setting the thickness like this allows the layer to be affixed with good conformity even with a large bump such as a protruding electrode. Accordingly, the thickness can be suitably adjusted according to the height of the protruding electrode on the semiconductor wafer to which the layer is affixed; however, the surface protective sheet of the present invention is particularly useful when the height of the protruding electrode is about 10 to 150 μm.

For example, it is suitable for the thickness of the adhesive layer to be about 20 μm or more, with about 30 to 200 μm being preferable. Such a thickness affords good conformity to the bump created by the protruding electrode on the semiconductor wafer, and minimizes cracking, dimpling, and the like during the thin-film working of the surface protective sheet. This also prevents the adhesive layer from oozing out from the surface protective sheet, and therefore reduces adhesion, fouling, and the like to the working apparatus that would otherwise be caused by this oozing, makes the sheet easier to affix, and ensures good work efficiency.

If the adhesive layer has a laminar structure comprising a first adhesive layer, a second adhesive layer, and the like up to the outermost layer, starting from the closest layer to the base film, then it is suitable for the outermost layer to be the thinnest layer in this laminar structure. More specifically, a range of about 5 to 30 μm is suitable. There are no particular restrictions on the thickness of the other layers, and the layer thickness may be varied randomly, for example, or any two layers may have the same thickness; however, it is suitable for the thickness to increase as a function of proximity to the base film.

The effect of having the outermost layer be the thinnest layer is that, as discussed below, even if the outermost layer is formed from a radiation curing type of adhesive and the adhesive of the outermost layer is cured by radiation in the peeling off of the surface protective sheet, good elasticity for the adhesive layer as a whole can be ensured by the adhesive layers present further inside, so that stress caused by peeling can be absorbed, for example, thereby allowing the surface protective sheet to be peeled away easily without damaging the wafer.

As discussed above, as long as it has a laminar structure comprising a plurality of layers, the adhesive layer can make use of the same adhesives used in known surface protective sheets, such as a pressure sensitive adhesive.

More specifically, acrylic adhesives, rubber-based adhesives, and a variety of other such materials can be used. Of these, an acrylic adhesive in which a base polymer is an acrylic polymer is preferable from the standpoints of adhesion to the semiconductor wafer, clean-up or detergency performance of the semiconductor wafer after peeling with an organic solvent such as alcohol or ultrapure water, and the like.

Examples of the acrylic polymer include an acrylic polymer derived from one monomer or at least 2 monomers, for example, an alkyl ester of a (meth)acrylic acid, i.e., a C₁ to C₃₀ (especially it is preferable linear or branched C₄ to C₁₈) alkyl (meth)acrylate, such as methyl (meth)acrylate, ethyl (meth)acrylate, propyl (meth)acrylate, isopropyl (meth)acrylate, butyl (meth)acrylate, isobutyl (meth)acrylate, sec-butyl (meth)acrylate, tert-butyl (meth)acrylate, pentyl (meth)acrylate, isopentyl (meth)acrylate, 2-ethylhexyl (meth)acrylate and octyl (meth)acrylate, as well as cycloalkyl (meth)acrylate, such as cyclopentyl (meth)acrylate and cyclohexyl (meth)acrylate. These monomers can be used alone or as mixture of two or more monomers.

In this specification, the (meth)acrylate means at least one of acrylate or methacrylate.

The acrylic polymer may be a copolymer that is copolymerized with the above monomer and another copolymerizable monomer, as needed, for the purpose of modifying the cohesive force, heat resistance, and the like.

Examples of such another monomer include;
a carboxyl- or acid anhydride-containing monomer such as (meth)acrylic acid, crotonic acid, carboxyethyl (meth)acrylate, carboxypentyl (meth)acrylate, itaconic acid, fumaric acid, maleic acid, maleic anhydride and itaconic anhydride;
a hydroxyl group-containing monomer such as 2-hydroxyethyl (meth) acrylate, 4-hydroxybutyl (meth)acrylate, 6-hydroxyhexyl (meth) acrylate, 8-hydroxyoctyl (meth)acrylate, 10-hydroxydodecyl (meth)acrylate, 12-hydroxyrauryl (meth) acrylate, (4-hydroxymethyl cyclohexyl) methyl(meth)acrylate;
a sulfonate-containing monomer such as styrenesulfonate, allylsulfonate, 2-(meth)acrylamide-2-methyl propanesulfonate, (meth) acrylamide propanesulfonate, sulfopropyl (meth)acrylate, (meth)acryloyl oxynaphthalenesulfonate;
a phosphate-containing monomer such as 2-hydroxyethyl acryloylphosphate;
an amino-containing monomer such as morpholino (meth)acrylate.

Examples of such another monomer may further include;
a vinyl esther such as vinyl acetate;
a styleme monomer such as stylene;
a cyano-containing monomer such as acrylonitrile;
a cyclic or non-cyclic (meth)acrylic amide; and a variety of other such monomers known as a monomer for the modification of the acrylic pressure sensitive adhesives.

Of these, it is preferable to use (meth)acrylic acid, and more preferably acrylic acid. These monomers are useful because they generate cross-linkage bonds in the polymer.

These monomers can be used alone or as mixture of two or more monomers.

The amount of the other copolymerizable monomers is preferable about 50 wt % or less of all of the monomer containing the acrylic monomer.

The acrylic polymer may also include a polyfunctional monomer or the like as needed, for the purpose of cross-linking and the like.

Examples of the polyfunctional monomer include hexanediol di(meth)acrylate, (poly)ethyleneglycol di(meth)acrylate, (poly)propyleneglycol di(meth)acrylate, neopentylglycol di(meth)acrylate, pentaerythritol di(meth)acrylate, trimethylolpropane tri(meth)acrylate, pentaerythritol tri(meth)acrylate, dipentaerythritol hexa(meth)acrylate, epoxy(meth)acrylate, polyester (meth)acrylate and urethane (meth)acrylate.

These polyfunctional monomers can be used alone or as mixture of two or more monomers.

In terms of adhesion characteristics and the like, the amount in which the polyfunctional monomer is used is preferably about 30 mol % or less of all of the monomer.

The acrylic polymer is obtained by polymerizing a single monomer or a mixture of two or more monomers. The polymerization can also be any method such as solution polymerization, emulsion polymerization, mass polymerization and suspension polymerization. Thus synthesized polymer can be used directly as the base polymer of the adhesive, but it is usually suitable to add a cross-linking agent or other additives for the purpose of improving the cohesive strength of the adhesive.

It is suitable for the weight average molecular weight of the acrylic polymer to be about 300,000 or higher, and about 400,000 to 3,000,000 is preferable. The weight average molecular weight of the polymer can be found by gel permeation chromatography (GPC).

In particular, it is suitable for the outermost layer of the adhesive layer to have a low content of low-molecular weight substances, from the standpoint of preventing fouling of the semiconductor wafer and the like. Therefore, in the outermost layer, the content of low-molecular weight substances with a weight average molecular weight of 100,000 or less is preferably no more than 20% of the weight of the outermost layer.

A polyfunctional (meth)acrylate and the like can be added as an internal cross-linking agent at the polymerization of the acrylic polymer, or a polyfunctional epoxy compound, an isocyanate compound, an aziridine compound, a melamine resin and the like can be added as an external cross-linking agent after the polymerization of the acrylic polymer in order to raise the weight average molecular weight of the base polymer, i.e., the acrylic polymer. A cross-linking treatment may be performed by radiation. Of these, an external cross-linking agent is preferably added to the adhesive. The term “polyfunctional” here means to have two or more functional groups.

Examples of the polyfunctional epoxy compound include, for example, sorbitol tetraglycidyl ether, trimethylolpropane glycidyl ether, tetraglycidyl-1,3-bisaminomethylcyclohexane, tetraglycidyl-m-xylenediamine and triglycidyl-p-aminophenol.

Examples of the polyfunctional isocyanate compound include, for example, diphenyl methandiisosianate, tolylene diisocyanate, hexamethylene and diisocyanate.

Examples of the aziridine compound include, for example, 2,2-bishydroxymethylbutanol-tris[3-(1-aziridinyl)propionate] and 4,4-bis(ethyleneiminocarbonylamino)diphenylmethane.

Examples of the melamine compound include, for example, hexamethoxymethylmelamine.

These cross-linking agents can be used alone or as mixture of two or more compounds. The amount used can be suitably adjusted according to the composition or molecular weight of the acrylic polymer and other such factors. To promote the reaction here, dibutyltin laurate or another such cross-linking catalyst that is normally used in adhesives may be used.

In addition to the above components, the adhesive may optionally comprise any known additive in the field such as a flexibilizer, antioxidant, curative agent, filler, ultraviolet absorbing agent, light stabilizer, polymerization initiator, tackifier, pigment and the like. These additives can be used alone or as mixture of two or more additives.

As a polymerization initiator, peroxides such as hydrogen peroxide, benzoyl peroxide and t-butyl peroxide may be used. One may be preferably used by itself, or it may be combined with a reducing agent and used as a redox type of polymerization initiator. Examples of the reducing agent include ionic salts such as salts of iron, copper, cobalt, sulfite, bisulfate; amines such as triethanol amine; reducing sugar such as aldose and ketose.

Also, an azo compound such as 2,2′-azobis-2-methylpropioamidine salt, 2,2′-azobis-2,4-dimethylvaleronitrile, 2,2′-azobis-N,N′-dimethylene-isobutylamidine salt, 2,2′-azobisisobutyronitrile and 2,2′-azobis-2-methyl-N-(2-hydroxyethyl) propionamide may be used as a polymerization initiator. These can be used alone or as mixture of two or more components.

In particular, it is preferable to add to the adhesive layer constituting the outermost layer a photopolymerization initiator that is excited and activated by irradiation with ultraviolet rays, thereby producing radicals, so that a polyfunctional oligomer can be cured by radical polymerization.

This makes it possible to use a radiation curing type of adhesive layer, and when the surface protective sheet is affixed, plastic fluidity is imparted to the adhesive by the oligomer component, so the sheet is easier to affix, and when the surface protective sheet is peeled away, radiation can be directed at the adhesive layer to cure it and effectively lower the adhesive strength.

The phrase “radiation curing adhesive layer” as used here means a layer whose adhesion is reduced through cross-linking/curing by radiation with an electron beam, ultraviolet rays, visible light, infrared rays or the like (of, for example, about 200 mJ/m² or more).

In this case, the other adhesive layers (the adhesive layers other than the outermost layer) may be a radiation curing type, or may be a non-radiation curing type.

In particular, when only the outermost layer is formed by a radiation curing adhesive layer, and the other adhesive layers are formed by a non-radiation curing adhesive, as mentioned above, even if the adhesive of the outermost layer is cured by radiation in the peeling of the surface protective sheet, elasticity of the adhesive layer as a whole can be ensured by the adhesive layers present further to the inside, so that stress caused by peeling can be absorbed, for example, thereby allowing the surface protective sheet to be peeled away easily without damaging the wafer.

Also, when a radiation curing adhesive is added to the adhesive layer closest to the base film (the first adhesive layer), if that first adhesive layer is cured with radiation during the grinding of the rear face of the semiconductor wafer, there will be less deformation of the adhesive layer. Therefore, it will be possible to prevent variance in the thickness of the wafer after grinding, which would otherwise be caused by the deformation of the adhesive layer.

In particular, it is suitable that the radiation curing adhesive includes a polymer, which is a photo-polymerized urethane acrylate oligomer with a monomer, and a photopolymerization initiator to be the radiation curing adhesive.

The urethane acrylate oligomer here means an oligomer having a molecular weight of about 500 to 100,000, preferably about 1,000 to 30,000, and being a bifunctional compound with ester diol as a main skeleton.

Examples of the monomer include morpholine (meth)acrylate, isobornyl (meth)acrylate, dicyclopentanyl (meth)acrylate, dicyclopentenyl (meth)acrylate and methoxylated cyclodecatriene (meth) acrylate.

The mixture ratio of the urethane (meth)acrylate oligomer and the monomer is preferably oligomer:monomer=about 95 to 5:5 to 95 (wt %), and more preferably about 50 to 70:50 to 30 (wt %).

Examples of the photopolymerization initiator include, for example,
an acetophenone photopolymerization initiator such as methoxy acetophenone, diethoxy-acetophenone (e.g., 2,2-diethoxy acetophenone), 4-phenoxydichloro acetophenone, 4-t-butyldichloro acetophenone, 2-hydroxy-2-methyl-1-phenylpropane-1-on, 1-(4-isopropylphenyl)-2-hydroxy-2-methylpropane-1-on, 1-(4-dodecylphenyl)-2-hydroxy-2-methylpropane-1-on, 4-(2-hydroxyethoxy)phenyl (2-hydroxy-2-propyl) ketone, 1-hydroxycyclohexyl phenyl ketone, 2-methyl-1-[4-(methyltio)phenyl]-2-morpholinoprophane-1 and 2,2-dimethoxy-2-phenyl acetophenone;
an α-ketol photopolymerization initiator such as 4-(2-hydroxyethoxy)phenyl(2-hydroxy-2-propyl)ketone, α-hydroxy-α, α′-dimethylacetophenone, 2-methyl-2-hydroxypropiophenon and 1-hydroxycyclohexylphenylketone;
a ketal photopolymerization initiator such as benzyldimethyl ketal;
a benzoine photopolymerization initiator such as benzoine, benzoine methyl ether, benzoine ethyl ether, benzoine isopropyl ether and benzoine isobutyl ether;
a benzophenone photopolymerization initiator such as benzophenone, benzoylbenzoate, benzoylbenzoate methyl, 4-phenyl benzophenone, hydroxy benzophenone, 4-benzoyl-4′-methyldiphenylsulfide and 3,3′-dimethyl-4-methoxybenzophenone;
a thioxanthone photopolymerization initiator such as thioxanthone, 2-chlorothioxanthone, 2-methylthioxanthone, 2,4-dimethylthioxanthone, isopropylthioxanthone, 2,4-dichlorothioxanthone, 2,4-diethylthioxanthone and 2,4-diisopropylthioxanthone;
an aromatic sulfonyl chloride photopolymerization initiator such as 2-naphthalene sulfonyl chloride;
a light-active oxime photopolymerization initiator such as 1-phenon-1,1-propanedione-2-(o-ethoxycarbonyl) oxime;
a specialized photopolymerization initiator such as α-acyloxim ester, methylphenyl glyoxylate, benzyl, camphor quinine, dibenzosuberone, 2-ethyl anthraquinone, 4′-4″-diethylisophthalophenone, ketone halide, acyl phosphinoxide and acyl phosphonate.

When reactivity is taken into account, it is suitable for the photopolymerization initiator to be added in an amount of about 0.1 weight parts or more, and preferably about 0.5 weight parts or more per 100 weight parts of the acrylic polymer or other such base polymer of the adhesive. If the amount is too large, there will be a tendency for the storage stability of the adhesive to decrease, so about 15 weight parts or less is suitable, and about 5 weight parts or less is preferable.

A radiation curing oligomer other than the above oligomer may be added to the adhesive. Examples of the oligomer include polyether, polyester, polycarbonate, polybutadiene and other oligomers. These oligomers can be used alone or as mixture of two or more oligomers. The oligomer is generally added in an amount of about 30 weight parts or less, and preferably about 10 weight parts or less per 100 weight parts of the base polymer.

At least one layer of the adhesive layer preferably contains, as its main component, an acrylic polymer having a carbon-carbon double bond in its molecule.

An adhesive whose main component is an acrylic polymer having a carbon-carbon double bond in its molecule usually is highly reactive and has high curability. Therefore, adhesive residue on the wafer surface after the surface protective sheet is peeled away can be reduced. Because of this, it is suitable for at least one of the layers of the adhesive layer to be an adhesive containing, as its main component, an acrylic polymer having a carbon-carbon double bond in its molecule, and preferably this layer is used only for the outermost layer.

Any method known in this field can be used to introduce a carbon-carbon double bond into a side chain in the acrylic polymer molecule. For example, for ease of molecular design and so forth, examples of the method include a method in which a monomer having a functional group is copolymerized to an acrylic polymer as a comonomer component, after which this polymer and a compound which has a carbon-carbon double bond and a functional group having reactivity to the functional group of the polymer are reacted (condensation, addition reaction, etc.) while radiation curing property of this carbon-carbon double bond is preserved.

Examples of the combination of the function groups include a combination of a carboxyl group and an epoxy group, a carboxyl group and an aziridine group, and a hydroxyl group and an isocyanate group. Of these, the combination of a hydroxyl group and an epoxy group is preferable from the view point of easy reaction trace.

In this case, examples of the isocyanate compound having a carbon-carbon double bond include methacryloyl isocyanate, 2-methacryloyloxyethyl isocyanate and m-isopropenyl-α,α-dimethylbenzyl isocyanate.

A hydroxyl group-containing compound that reacts with this isocyanate compound can be suitably selected from among the compounds listed above.

There are no particular restrictions on the base film and any base film that is known in this field can be used.

Examples of the base film include a film made of a polymer, for example, polyolefins such as low-density polyethylene, liner polyethylene, medium-density polyethylene, high-density polyethylene, ultralow density polyethylene, random copolymer polypropylene, block copolymer polypropylene, homo-polypropylene, polybutene, polymethylpentene; polyurethane, ethylene-vinyl acetate copolymer, ionomer resin, ethylene-(meth)acrylic acid copolymer, ethylene-(meth)acrylic ester (random or alternating) copolymer, ethylene-butene copolymer, ethylene-hexene copolymer; polyester such as polyethylene terephthalate; polyimide, poly etheretherketone, polyvinylchoride, polyvinylidene chloride, fluorine resin, cellulose resin, and cross-linked material thereof. These can be used alone or as mixture of two or more. The base film can be formed as a single layer or as a multilayer of two or more layers.

The thickness of the base film is generally about 5 to 400 μm, preferably about 10 to 300 μm, and more preferably about 30 to 200 μm.

The base film can be formed by a known film forming method, such as wet casting, inflation, T die extrusion or the like. The base film may be undrawn, or may have undergone uniaxial or biaxial drawing.

One or both sides of the base film may have undergone matte treatment, corona treatment, priming, cross-linking (chemical cross-linking (slime)) or other such physical or chemical treatment.

If a radiation curing adhesive is used as the adhesive layer of the surface protective sheet of the present invention, it is suitable to use a material of the base film that will transmit at least the required amount of radiation (such as a transparent or light permeability resin) in order to pass the radiation through the base film.

The surface protective sheet of the present invention may comprise a plurality of the above-mentioned adhesive layers on one side of the base film, and may comprise a single adhesive layer or laminated adhesive layers or the like on both sides of the base film.

Also, it is preferable if a removable film is provided over the adhesive layer until the time of use so as to protect the adhesive layer.

There are no particular restrictions on the form of the surface protective sheet, which may be in the form of a sheet, a tape or the like.

In the manufacture of the surface protective sheet of the present invention, the adhesive layer may be formed as a thin film by redissolving a collected polymer in an organic solvent as needed, and applying it directly over a base film by a known coating method such as a roll coater. Another method that can be used is to form the adhesive layer by coating a suitable removable liner (separator), and transferring this over to the base film. When the layer is formed by the transfer, any voids generated at the interface between the base film and the adhesive layer can be expanded and popped or diffused by performing a heating and pressurizing treatment, such as in an autoclave, after the transfer to the base film.

Also, when a polymer is manufactured by solution polymerization, emulsion polymerization or the like, the adhesive layer can be formed by coating the base film or separator or the like by a known method with the resulting polymer solution or polymer aqueous dispersion.

The adhesive layer formed in this manner may, if needed, be cross-linked in a drying step or in a subsequent light irradiation step, electron beam irradiation step, or the like.

The surface protective sheet of the present invention can be utilized, for example, as a surface protective sheet for the back-grinding of a silicon semiconductor, a surface protective sheet for the back-grinding of a compound semiconductor, a surface protective sheet for the dicing of a silicon semiconductor, a surface protective sheet for the dicing of a compound semiconductor, a surface protective sheet for the dicing of a semiconductor package, a surface protective sheet for glass dicing, a surface protective sheet for ceramic dicing, for protecting a semiconductor circuit and the like. In particular, this sheet can be affixed to one side of the semiconductor wafer when a semiconductor wafer rear face is polished, e.g., when the semiconductor wafer is being ground extremely thin and/or when a large-diameter wafer is being ground, etc. Also, it can be utilized for surface protection on the insides of a manufacturing apparatus, etc.

This sheet can be used in a wide range of applications such as;
removal of debris in the manufacture and machining of various products and parts that entail the peeling away of a surface protective sheet, and in various kinds of manufacturing apparatus;
surface protection against corrosion (rust), shavings and the like produced by cutting water during dicing and the like;
masking, and so forth, either during the use of this surface protective sheet or at the end of its use.

The surface protective sheet of the present invention will now be described in detail on the basis of examples. All parts and percentages in the examples and comparative examples are by weight unless otherwise indicated.

### Base Film

A film made from ethylene vinyl acetate copolymer (EVA) having a thickness of 140 μm was used as a base film.

### Adhesive Layers

82 parts 2-ethylhexyl acrylate, 3 parts of acrylic acid and 15 parts acrylamide were copolymerized by a standard method in ethyl acetate to obtain a solution containing an acrylic copolymer with a weight average molecular weight of 700,000.

To this obtained solution were added 10 parts urethane acrylate oligomer (trade name “UV-3000B,” made by Nippon Synthetic Chemical Industry), 3 parts polyisocyanate compound (trade name “Coronate L,” made by Nippon Polyurethane Industry), 0.1 parts epoxy cross-linking agent (trade name “tetrad C,” made by Mitsubishi gas chemical company, Inc.) and 3 parts acetophenone photopolymerization initiator (trade name “Irgacure 651,” made by Ciba Specialty Chemicals) and mixed to prepare a radiation-curing type adhesive solution.

This solution was used to coat a release-treated film and was dried to form a first adhesive layer.

A blend monomer composed of 35 parts ethylhexyl acrylate, 45 parts of butyl acrylate and 20 parts 2-hydroxyethyl acrylate was copolymerized in toluene to obtain an acrylic copolymer with a weight average molecular weight of 300,000.

100 parts of this obtained polymer was additionally polymerized with 20 parts 2-methacroyloxyethylisocyanate to introduce carbon-carbon double bonds into a side chain in the polymer molecule.

To 100 parts of this obtained polymer were added 10 parts urethane acrylate oligomer (trade name “UV-3000B,” made by Nippon Synthetic Chemical Industry), 0.2 parts polyisocyanate compound (trade name “Coronate L,” made by Nippon Polyurethane Industry) and 3 parts acetophenone photopolymerization initiator (trade name “Irgacure 651,” made by Ciba Specialty Chemicals) and mixed to prepare a radiation-curing type adhesive solution.

This solution was used to coat a release-treated film and was dried to form a second adhesive layer.

### Production of Surface Protective Sheet

A surface protective sheet is obtained by laminating the first adhesive layer and the second adhesive layer, in that order, on one side of the base film, and then laminating a separator consisting of release paper in order to protect the surface of the second adhesive layer, thereby resulting in the surface protective sheet.

### EXAMPLES 1 TO 3 AND COMPARATIVE EXAMPLES 1 TO 3

Surface protective sheets were produced by variously adjusting the thickness of the first and second adhesive layers as shown in Table 1. Also, the separator was peeled from each of the surface protective sheets, the adhesive layer was affixed to a silicon wafer having a protruding electrode with the height shown in Table 1 on its surface, and the following evaluations were conducted, respectively.

### Apparatus Used

Wafer bonding apparatus: NELDR-8500II produced by Nitto Seiki,

UV irradiation apparatus: UM810 produced by Nitto Seiki,

Grinding apparatus: Silicon wafer grinding apparatus produced by DISCO, and

Peeling apparatus: HR-8500II produced by Nitto Seiki.

### Measurement of Storage Elastic Modulus of Adhesive Layer

An ARES kinematic viscoelasticity measurement device made by Rheometric was used to measure the 25° C. storage elastic modulus of an adhesive layer (a test sample having a thickness of 2.0 mm, produced by laminating the first and/or second adhesive layers, at a frequency of 1 Hz and a contact bonding pressure of 100 g, with 7.9 mm parallel plates placed in a jig. When there was a plurality of layers in the adhesive layer, the sample was produced so that the total thickness of the adhesive layer was 2 mm with the thickness of each layer proportionally adjusted. When the adhesive layer consisted of a single layer, the sample was produced so that the total thickness was 2 mm for just the single layer. After the sample was produced, it was irradiated with ultraviolet rays of 300 mJ/cm², and the storage elastic modulus was measured.

### Measurement of Adhesive Strength to Silicon Mirror Wafer

The surface protective sheet with a width of 20 mm was contact bonded to the surface of a silicon mirror wafer using a roller with a weight of 2 kg. This product was irradiated with ultraviolet rays of 300 mJ/cm², and then a tensile tester (Tensilon) was used to measure the value of the adhesive strength when sheet was peeled off at a peeling angle of 180°. The peeling rate was 300 mm/minute.

### Method for Checking Conformity of Surface Protective Sheet to Protruding Electrode

A wafer with an attached protruding electrode was placed on a table, over which the surface protective sheet was affixed with a contact bonding roll. The wafer (not including the protruding electrode) was 8 inches, and 725 μm-thickness.

After this, the rear face of the wafer was ground until the thickness reached 100 μm, then it was irradiated with ultraviolet rays, and the surface protective sheet was then peeled off.

To evaluate the conformity to the protruding electrode when the surface protective sheet was affixed to the wafer, amount of the air bubble generated around the protruding electrode under the sheet was examined with an optical microscope at a magnification of 100×. A grade of “poor” was given if there was a bubble around the protruding electrode.

### Peelability

After the rear face of the wafer with the attached protruding electrode had been ground, the surface protective sheet was irradiated with ultraviolet rays of 300 mJ/cm². Thereafter, the above-mentioned peeling machine was used to peel off the sheet at a rate of 300 mm/minute, and whether or not the sheet was peelable was checked.

If the adhesive sheet tore or broke during the peeling of the surface protective sheet, or if the surface protective sheet could not be peeled off from the wafer, peeling was deemed to have failed and a grade of “x” was given. On the other hand, if the surface protective sheet could be peeled off without any of such failures, a grade of “o” was given.

### Adhesive Residue

After checking whether or not the sheet could be peeled off after UV irradiation, the wafer surface was examined with an optical microscope at a magnification of 100×, and the amount of adhesive residue on the wafer surface was examined. If adhesive residue was observed on the protruding electrode or in its surrounding area, an evaluation of “no” to adhesive residue was not given, and an evaluation of “yes” to adhesive residue was given instead.

TABLE 1

| | Ex. | | | Comp. Ex. | | |
|---|---|---|---|---|---|---|
| | 1 | 2 | 3 | 1 | 2 | 3 |
| Base Film/Thickness (μm) | EVA/140 | | | | | |
| 1st adhesive layer Thickness (μm) | 50 | 70 | 120 | 60 | 0 | 30 |
| 2nd adhesive layer Thickness (μm) | 10 | 10 | 20 | 0 | 80 | 10 |
| Adhesive Layer Total Thickness (μm) | 60 | 80 | 140 | 60 | 80 | 40 |
| Protruding Electrode Height (μm) | 20 | 50 | 100 | 20 | 50 | 50 |
| 25° C. Storage Elastic Modulus (MPa) | 80 | 50 | 20 | 2 | 150 | 95 |
| Adhesive Strength to Silicon Mirror Wafer (N/20 mm) | 0.3 | 0.4 | 0.5 | 3.0 | 0.3 | 0.3 |
| Conformity | ∘ | ∘ | ∘ | ∘ | ∘ | x* |
| Peelability | ∘ | ∘ | ∘ | x | x | ∘ |
| Adhesive Residue | no | no | no | yes | no | yes |

*There was a bubble around the protruding electrode.

The surface protective sheet of the present invention is useful not only in the polishing of semiconductor wafers and the like, but also for protecting wafers and the like in various steps of working the wafers, for masking, or as a surface protective sheet that needs to be re-peelable, such as for tacking, fixing, etc.

It is to be understood that although the present invention has been described in relation to preferred embodiments thereof, various other embodiments and variants may occur to those skilled in the art as within the scope and spirit of the invention, and such other embodiments and variants are intended to be covered by the following claims.

What is claimed is:

1. A surface protective sheet comprising an adhesive layer having a plurality of layers on one side of a base film,
the adhesive layer having a 25° C. storage elastic modulus of 10 to 100 MPa, and an adhesive strength with respect to a silicon mirror wafer of 1.0 N/20 mm or less at peeling off the surface protective sheet, and
the surface protective sheet being used for a semiconductor wafer having a protruding electrode of 10 to 150 μM height on its surface.

2. The surface protective sheet according to claim 1, wherein the adhesive layer has a thickness greater than the height of the protruding electrode.

3. The surface protective sheet according to claim 1, wherein the adhesive layer has an outermost layer made of a radiation curing type of adhesive.

4. The surface protective sheet according to claim 1, wherein the adhesive layer has an outermost layer being the thinnest layer.

5. The surface protective sheet according to claim 1, wherein at least one of the plurality of layers in the adhesive layer contains an acrylic polymer having a carbon-carbon double bond, as a main component.
